(19) United States
(12) Patent Application Publication
(10) Pub. No.: US 2020/0027151 A1
(43) Pub. Date: Jan. 23, 2020

(54) METHOD AND APPARATUS FOR PROVIDING RECOMMENDATION INFORMATION FOR ITEM

(71) Applicant: Snow Corporation, Seongnam-si (KR)

(72) Inventors: Seongyeop Jeong, Seongnam-si (KR); Byung-Sun Park, Seongnam-si (KR); Sangho Choi, Seongnam-si (KR); Junghwan Jin, Seongnam-si (KR); Wonhyo Yi, Seongnam-si (KR); Hyeongbae Shin, Seongnam-si (KR); Sungwook Kim, Seongnam-si (KR); Noah Hahm, Seongnam-si (KR); Jimin Kim, Seongnam-si (KR)

(73) Assignee: Snow Corporation, Seongnam-si (KR)

(21) Appl. No.: 16/586,001

(22) Filed: Sep. 27, 2019

Related U.S. Application Data
(63) Continuation of application No. PCT/KR2017/003501, filed on Mar. 30, 2017.

(51) Int. Cl. G06Q 30/06; G06F 16/532; G06N 3/00; G06F 16/535; G06F 16/9535; G06F 16/538

(52) U.S. Cl. CPC G06Q 30/0631; G06F 16/532; G06F 16/538; G06F 16/535; G06F 16/9535; G06N 3/006

(57) ABSTRACT

A method includes acquiring item information associated with a first item; acquiring a first image of the first item and second images of at least one second item associated with the first item by searching an image information database based on the item information; generating recommendation information associated with the first item based on the first image and the second images; and outputting the recommendation information to a user terminal.

### CROSS-REFERENCE TO RELATED APPLICATION

This application is a continuation of PCT International Application No. PCT/KR2017/003501, which has an International filing date of Mar. 30, 2017, the entire contents of which are incorporated herein by reference.

### BACKGROUND

### Technical Field

Example embodiments relate to a method and/or apparatus for providing recommendation information about an item. For example, at least some example embodiments relate to a method and/or apparatus for acquiring an image of an item and an image of a related item based on item information of the item, generating a composite image by combining acquired images, and providing recommendation information that includes the generated composite image.

### Related Art

As online sales of clothes or accessories are growing and users' interest on fashion is also increasing, a method of recommending clothes or accessories preferred by a user is proposed.

However, such a method of recommending clothes or accessories merely offers image or purchase information of corresponding clothes or accessories as recommendation information in response to a search request from a user and thus, is not readily usable by the user. Further, a recommendation on other clothes or accessories that match clothes or accessories owned by the user is not provided to the user.

The aforementioned information is merely provided to help understanding and may include content that does not constitute a portion of the related art and may not include content that may be offered from the related art to those skilled in the art.

### SUMMARY

At least some example embodiments are directed to a method of providing recommendation information.

At least some example embodiments are directed to a method that may determine a plurality of recommendation items fitting an item a user owns or desires to own and may provide recommendation information in which the plurality of recommendations items are offered in a single recommendation image or a single recommendation video. By providing a plurality of recommendation items on an item owned by a user through a single recommendation image or a single recommendation video, the user may be provided with coordination information suitable for the item in an intuitive manner.

According to some example embodiment, a user may be provided with additional information, such as purchase information or details, on a recommendation item in response to receiving a selection from the user on acquired recommendation information.

According to some example embodiment, a user may easily verify purchase information or details about a recommendation item included in recommendation information, in response to a selection on the provided recommendation information.

According to some example embodiments, a user may be provided with desired (or, alternatively, optimal) images for recommendation items and an item owned by the user by searching an image information database Accordingly, it is possible to provide recommendation information highly available as coordination information.

In some example embodiments, the method includes acquiring item information associated with a first item; acquiring a first image of the first item and second images of at least one second item associated with the first item by searching an image information database based on the item information; generating the recommendation information associated with the first item based on the first image and the second images; and outputting the recommendation information to a user terminal.

In some example embodiments, the acquiring the item information includes acquiring the item information from an item information database.

In some example embodiments, the method further includes generating the item information in response to one of a user capturing the first item via an image capturing device of the user terminal or the user purchasing the first item.

In some example embodiments, the acquiring of the first image and the second images includes selecting the first image and the second images from among candidate images such that the first item and the at least one second item are output to be visually recognizable to a user through the recommendation information.

In some example embodiments, the selecting the first image and the second images includes selecting at least one of the first image and the second images such that the at least one of the first image and the second images includes only the first item or the at least one second item and a background.

In some example embodiments, the selecting the first image and the second images includes selecting at least one of the first image and the second images as an image that includes a shape of a front of a related item.

In some example embodiments, the selecting the first image and the second images includes selecting at least one image of the first image and the second images as an image in which a rotation angle of a shape of an item related to the image is less than or equal to a desired value with respect to at least one axis based on a frame of the image.

In some example embodiments, the selecting the first image and the second images includes selecting at least one image of the first image and the second images to have a resolution of at least a desired value.

In some example embodiments, the selecting the first image and the second images includes selecting the first image and the second images to include an entire shape of a related item.

In some example embodiments, the method further includes determining the at least one second item associated with the first item based on information indicating at least one of (i) a type of the first item, (ii) a current season (iii) a geographical region associated with the user terminal, (iv) statistical information, and (v) preference information.

In some example embodiments, the first item is wearable to a first part of a body and the second item is wearable to a second part of the body excluding the first part, and the generating of the recommendation information includes arranging the first image and the second images based on relative positions of the first part and the second part relative to the body to generate an arranged first image and arranged second images, respectively; and generating the recommendation information by composing the arranged first image and the arranged second images in one of a single recommendation image or a single recommendation video.

In some example embodiments, the arranging of the first image and the second images includes determining a position corresponding to a specific part of a virtual body as a reference position; and arranging the first image and the second images in one of a single recommendation image or a single recommendation video based on the reference position.

In some example embodiments, the method further includes replacing at least one of the first item and the second item with at least one third item in response to a selection from the user after displaying the recommendation information; generating modified recommendation information that includes a third image of the third item; and outputting the modified recommendation information to the user terminal.

In some example embodiments, the second item is purchasable by a user of the user terminal.

In some example embodiments, the method further includes connecting the user terminal to a website to purchase the second item based on a selection of the second item.

In some example embodiments, a user of the user terminal possesses at least one of the first item and the at least one second item.

In some example embodiments, the generating of the recommendation information includes generating a virtual model of a user of the user terminal based on the recommendation information such that the virtual model is virtually fitted with the first item and the at least one second item.

Some example embodiments are directed to a program to perform a method of providing recommendation information.

Some example embodiments are directed to a method of providing recommendation information.

In some example embodiments, the method includes transmitting, to a server, a request for recommendation information associated with a first item based on item information associated with the first item; receiving the recommendation information from the server in response to the request such that the recommendation information combines a first image of the first item and second images of at least one second item associated with the first item, the first image and the second images being acquired via an image information database based on the item information; and displaying, on a display device, the recommendation information.

### BRIEF DESCRIPTION OF DRAWINGS

FIG. 1 illustrates a method of providing recommendation information about an item owned by a user according to an example embodiment.

FIG. 2 illustrates a method of conducting an image search based on item information and providing recommendation information through image composition according to an example embodiment.

FIG. 3 is a block diagram illustrating a configuration of a server configured to provide recommendation information, a user terminal configured to output recommendation information, and a related database according to an example embodiment.

FIG. 4 is a flowchart illustrating a method of conducting an image search based on item information about an acquired first item and providing recommendation information to a user terminal according to an example embodiment.

FIG. 5 is a flowchart illustrating an example of a method of generating recommendation information and a method of arranging a first image and a second image in generating the recommendation information according to an example embodiment.

FIG. 6 is a flowchart illustrating an example of a method of generating modified recommendation information by modifying recommendation information and providing the modified recommendation information to a user terminal according to an example embodiment.

FIG. 7 is a flowchart illustrating a method of requesting, by a user terminal, recommendation information about an item and receiving and outputting the recommendation information according to an example embodiment.

FIG. 8 illustrates an example of a method of selecting a suitable image for generating recommendation information according to an example embodiment.

FIG. 9 illustrates an example of a method of displaying modified recommendation information and providing additional information as well as purchase information about a recommended item according to an example embodiment.

### DETAILED DESCRIPTION

Hereinafter, example embodiments are described with reference to the accompanying drawings.

In the following description, “providing” information/data from one component to another component may represent “transmitting or transferring” information/data from the one component to the other component. For example, “providing a service, for example, recommendation information” to a user terminal may represent “transmitting or transferring information/data” required to output a corresponding service or content associated with the service to the user terminal.

Also, “providing a service through a user terminal” may represent outputting, to the user terminal, the information or the content such that a user of the user terminal may identify content associated with a corresponding service.

Also, the term “user” in the following description may represent a “user terminal” of the user as well as the user itself. For example, providing information, data, content, or a service to the user may be understood to provide or output the information, the data, the content, or the service to the user terminal.

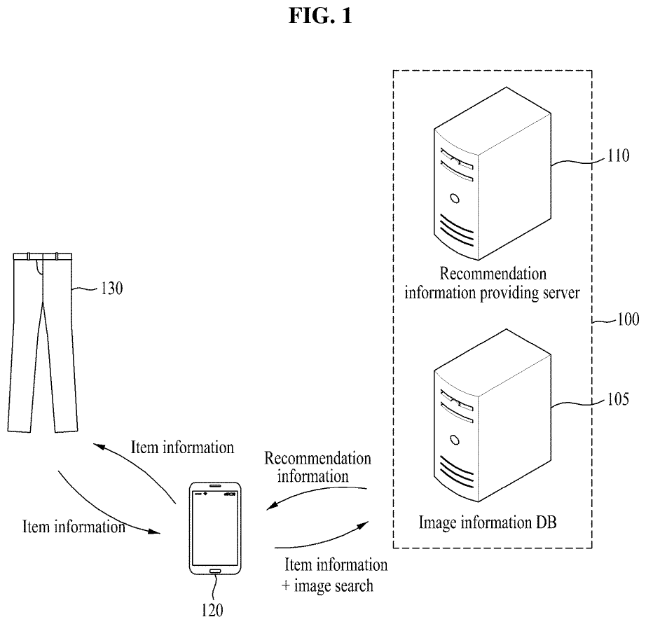

FIG. 1 illustrates a method of providing recommendation information about an item owned by a user according to an example embodiment.

Referring to FIG. 1, a user acquires information about an item 130 the user owns or desires to own using a user terminal 120, and receives recommendation information about another item associated with the item 130 from a server 100 using the acquired information about the item.

Although FIG. 1 illustrates that the item 130 corresponds to “pants”, the item 130 may be a user wearable item, for example, clothes such as top or bottom and any type of accessories such as a cap, shoes, sunglasses, neckless, and earrings.

The item 130 may refer to an item the user owns or desires to own. Expression “the user owns the item 130” may represent that the user holds a right to own the item 130 and also temporarily occupies or has the item 130 or is non-temporarily using the item 130. Expression “the item 130 the user desires to own” may represent an item for which the user has the intent of owning. For example, the item 130 may indicate an item the user desires to purchase.

The user may acquire item information by capturing the item 130 using a camera of the user terminal 120. Alternatively, item information of the item 130 may be stored in the user terminal 120, or may be acquired from an item information database present outside the user terminal 120.

The user terminal 120 may request the server 100 for recommendation information using the acquired item information. A recommendation information providing server 110 of the server 100 may determine a first image suitable for the item 130 and a second image suitable for at least one recommendation item of the item 130 by searching an image information database 105. The recommendation information providing server 110 may generate a recommendation image (composite image) or a recommendation video (composite video) by combining (composing) the first image and the second image, and may provide the recommendation information including the same to the user terminal 120.

The user terminal 120 may output the recommendation information received through the recommendation information providing server 110, and the user may verify the recommendation image or the recommendation video included in the recommendation information, may verify a recommendation item that fits the item 130, and may acquire additional information about the recommendation item.

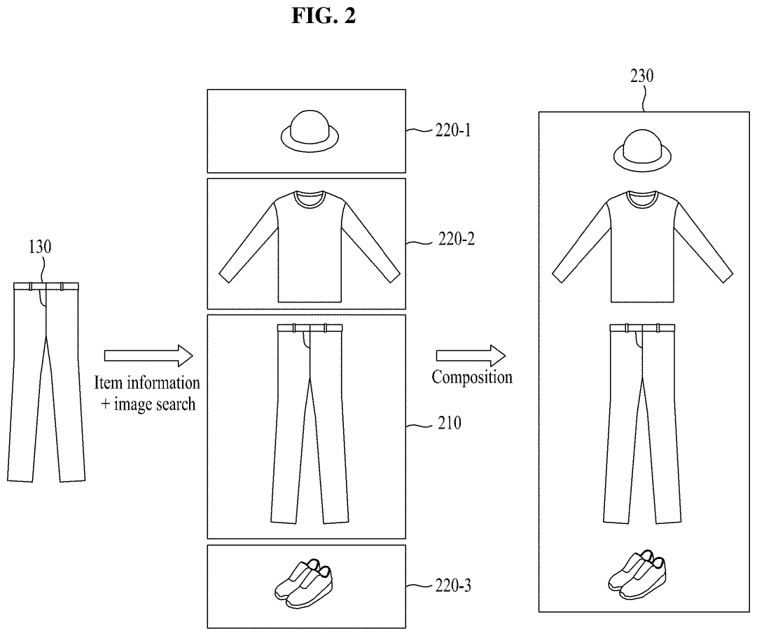

A method of generating recommendation information and a method of providing the generated recommendation information to the user terminal 120, and configurations of the server 100 and the user terminal 120 are further described with reference to FIGS. 2 to 9.

FIG. 2 illustrates a method of conducting an image search based on item information and providing recommendation information through image composition according to an example embodiment.

Referring to FIG. 2, a method of searching the image information database 105 based on item information of the item 130 the user owns or desires to own, determining a first image 210 of the item 130 and second images 220-1, 220-2, and 220-3 of items associated with the item 130, which are used to generate desired recommendation information 230, and generating recommendation information 230 by composing the first image 210 with the second images 220-1 to 220-3 is described with reference to FIG. 2.

As described above with reference to FIG. 1, the recommendation information providing server 110 may acquire the images 210 and 220-1 to 220-3 by searching the image information database 105 based on the item information of the item 130 acquired from the item information database or by capturing the item 130 using a camera of the user terminal 120.

In detail, the recommendation information providing server 110 may identify the item 130 and may determine recommendation items associated with the item 130 based on the item information of the item 130. For example, as illustrated, the recommendation information providing server 110 may identify the item 130 as pants, and may determine a cap, a top, and/or shoes as the recommendation items.

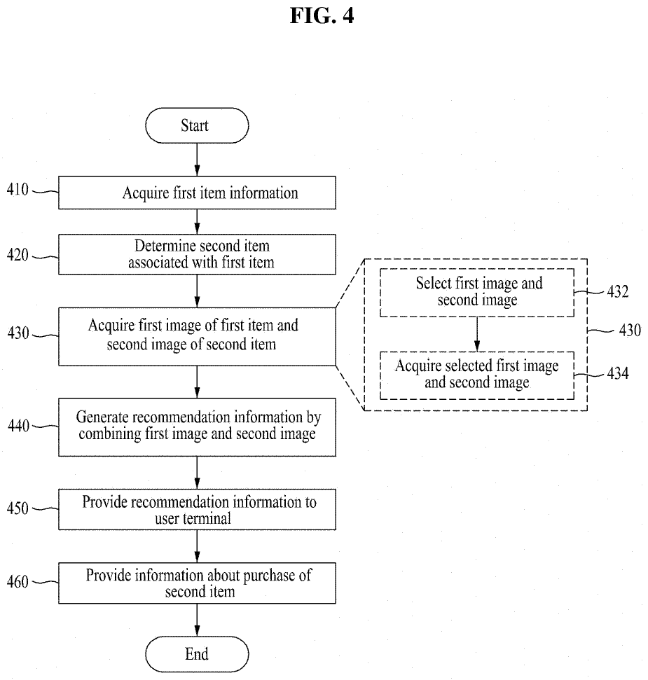

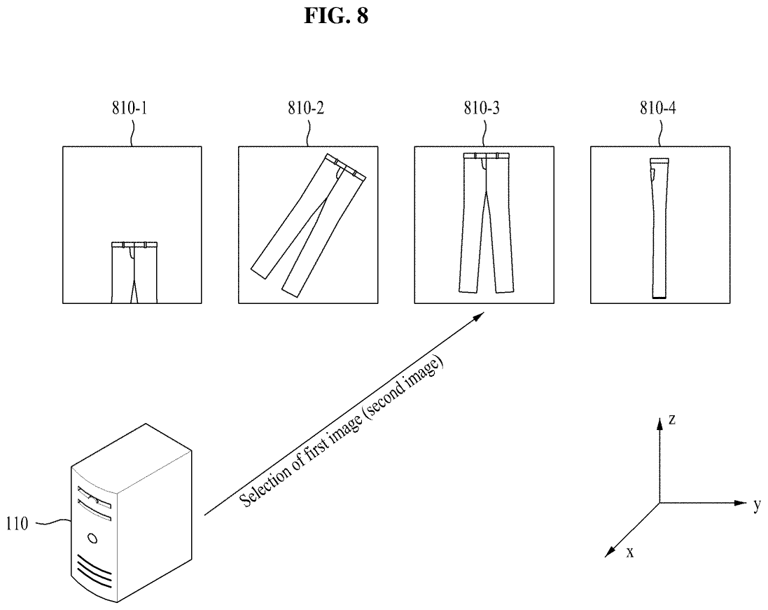

The recommendation information providing server 110 may determine the first image 210 suitable for the recommendation information 230 from the image information database 105 based on the item information of the item 130, and may determine the second images 220-1, 220-2, and 220-3 of the recommendation items determined to be suitable for the recommendation information 230. Each of the first image 210 and the second images 220-1, 220-2, and 220-3 may be selected from among a plurality of candidate images. A method of determining the first image 210 and the second image suitable for the recommendation information 230 is further described with reference to FIGS. 4 and 8.

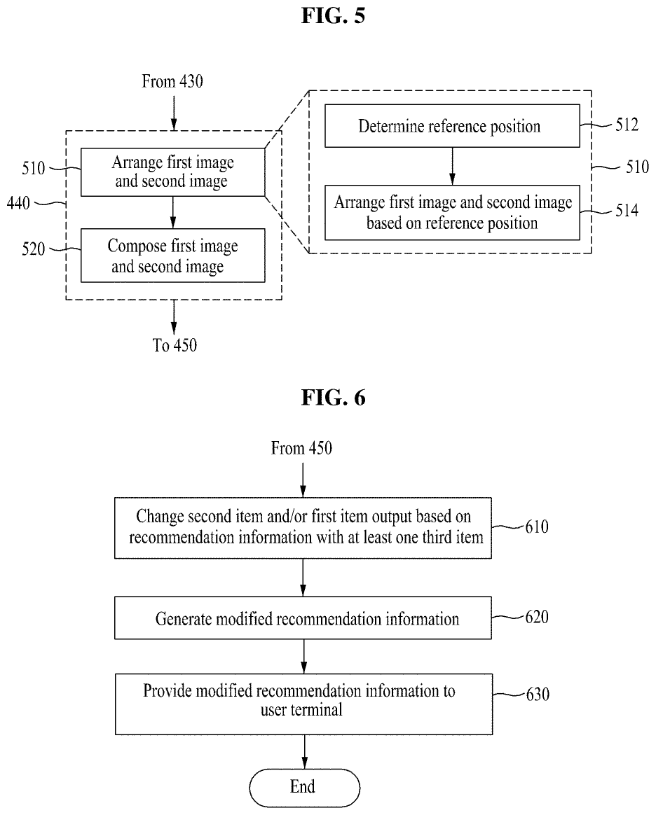

The recommendation information providing server 110 may generate the recommendation information 230 that includes a recommendation image corresponding to a single composite image or a recommendation video corresponding to a single composite video by composing the determined images, for example, the first image 210 and the second images 220-1, 220-2, and 220-3. A method of generating the recommendation information 230 is further described with reference to FIGS. 4 and 5.

The generated recommendation information 230 may be output to the user terminal 120 in a form corresponding to coordination recommendation information of, for example, clothes and/or accessories provided through advertisements or magazines.

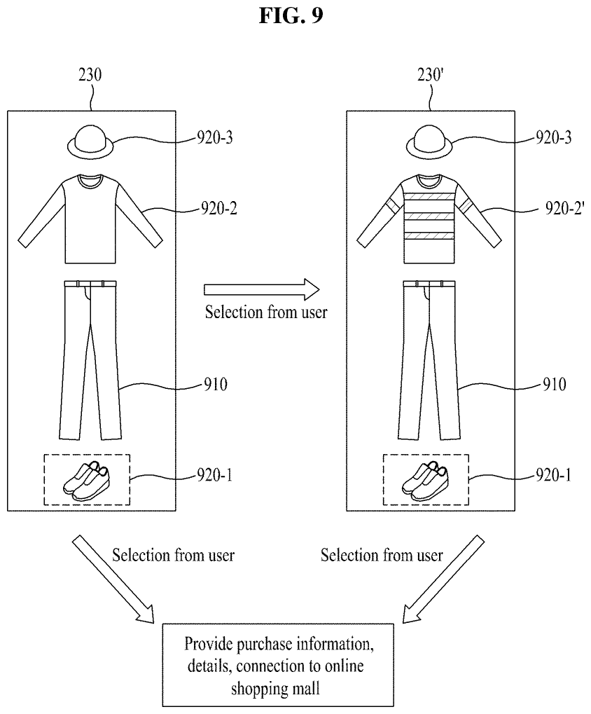

The user may receive a piece of advice on coordination of the item 130 the user owns or desires to own through the recommendation information 230 and may easily verify images of recommendation items that are recommended for the item 130. Example embodiments of providing the recommendation information 230 to the user terminal 120 are further described with reference to FIGS. 6 and 9.

Description related to technical features made above with reference to FIG. 1 may apply to FIG. 2 and accordingly, further description is omitted.

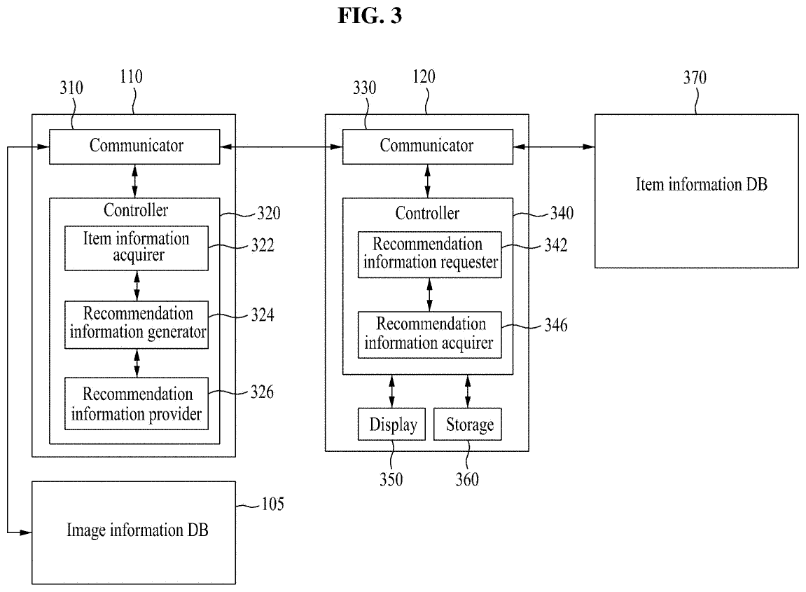

FIG. 3 is a block diagram illustrating a configuration of a server configured to provide recommendation information, a user terminal configured to output recommendation information, and a related database according to an example embodiment.

Referring to FIG. 3, the image information database 105 and an item information database 370 in addition to the recommendation information providing server 110 and the user terminal 120 of FIGS. 1 and 2 are further described.

The recommendation information providing server 110 (hereinafter, also referred to as the server 110) may be an apparatus configured to communicate with the user terminal 120 and the image information database 105, and to generate recommendation information and to provide the generated recommendation information to the user terminal 120 in response to a request from the user terminal 120. Also, the server 110 may be a server configured to manage/operate a user terminal application or program used for the user terminal 120 to request, receive, and output the recommendation information 230.

The server 110 may include a communicator 310 and a controller 320.

The communicator 310 may be configured to communicate with another apparatus as well as the user terminal 120. The communicator 310 may be a hardware module, for example, a network interface card, a network interface chip, and a networking interface port of the server 110 that transmits/receives data and/or information to/from another apparatus (database or another server) as well as the user terminal 120. Also, the communicator 310 may be a software module, for example, a network device driver or a networking program.

The controller 320 may manage components of the server 110, may execute a program or an application used for the server 110 to generate and provide the recommendation information 230, and may process related data and operation. The controller 320 may be at least one processor of the server 110 or at least one core in the processor.

The controller 320 may include an item information acquirer 322, a recommendation information generator 324, and a recommendation information provider 326. The components 322, 324, and 326 of the controller 320 may be software or hardware modules configured in the controller 320 or in at least one processor of the controller 320. Accordingly, functions and operations of the components 322, 324, and 326 of the controller 320 may be executed by at least one processor.

For example, the controller 320 may include processing circuitry such as hardware including logic circuits, a hardware/software combination such as a processor executing software; or a combination thereof. For example, the processing circuitry may include, but is not limited to, a central processing unit (CPU), an arithmetic logic unit (ALU), a digital signal processor, a microcomputer, a field programmable gate array (FPGA), a System-on-Chip (SoC) a programmable logic unit, a microprocessor, or an application-specific integrated circuit (ASIC), etc.

The processing circuitry may execute instructions stored in the memory to configure the processing circuitry as special purpose processing circuitry to perform the operations of the item information acquirer 322, the recommendation information generator 324, and the recommendation information provider 326. Therefore, the processing circuitry may improve the functioning of the server 110 and the terminal device 120 by providing recommendation information regarding second items purchasable or possessed by the user based on a first item possessed by the user in an intuitively easy manner. The special purpose processing circuitry may provide the recommendation information by generating and storing item information based on, for example, a digital image of the first item captured by the user terminal 120 or automatically upon purchase of the first item by the user, may subsequently use the item information to automatically determine at least one second item that is compatible with the first item, and may automatically generate the recommendation information by performing image processing on a first image corresponding to the first item and second images corresponding to the at least one second item such that the first item and the at least one second item appear in a two-dimensional (or, alternatively, a three-dimensional) space with the first item and the at least one second item arranged in locations based on typical arrangements of the item relative to a wearer of the items.

The controller 320 operating as the item information acquirer 322 may acquire item information about the item 130 (hereinafter, also referred to as the first item 130) the user owns or desires to own. The item information may be acquired from the user terminal 120 using the communicator 310 or may be acquired from the item information database 370 through the user terminal 120.

The controller 320 operating as the recommendation information generator 324 may determine at least one second item (recommendation item) associated with the first item 130 based on the item information acquired by the item information acquirer 322. Also, the recommendation information generator 324 may acquire the first image 210 of the first item 130 and the second image(s) 220-1, 220-2, and 220-3 of the second item(s) by searching the image information database 105. The item information acquirer 322 may generate the recommendation information 230 about the first item 130 that includes a single recommendation image or a single recommendation video by combining the first image 210 and the second images 220-1, 220-2, and 220-3.

The recommendation information generator 324 may further use information acquired from an additional database to generate the recommendation information 230 or to determine second item(s) to be included in the recommendation information 230. For example, the recommendation information generator 324 may use additional information acquired from an environmental information database (not shown) and/or a statistical information database (not shown) to generate the recommendation information 230. The environmental information database or the statistical information database may be constructed inside or outside the server 100.

The controller operating as the recommendation information provider 326 may provide the generated recommendation information 230 to the user terminal 120 of the user. The recommendation information provider 326 may transmit the recommendation information 230 to the user terminal 120 using the communicator 310.

Functions and operations of the components 322, 324, and 326 of the controller 320 are further described with reference to FIGS. 4 to 9.

The image information database 105 may be a database configured to store images of the first item and the second item. For example, the image information database 105 may be a database configured to store images displayed as a result of “image search” of a portal site.

The image information database 105 and the server 110 may be constructed in a single server 100 as shown in FIG. 1. For example, the server 110 may include a memory device such as a hard disk drive (HDD), a solid state drive (SSD), a random access memory (RAM), or any other suitable volatile, non-volatile, or combination of volatility and non-volatility memory device. The memory device may be configured to operate as the image information database 105.

Alternatively, the image information database 105 may be constructed in a separate server different from the server 110.

Hereinafter, the user terminal 120 that requests the server 110 to provide the recommendation information 230 and receives and outputs the recommendation information 230 is described.

Although FIG. 1 illustrates the user terminal 120 as a smartphone or a device similar thereto, the user terminal 120 may be a personal computer (PC), a notebook (laptop computer), a laptop computer, a tablet, an Internet of things (IoT) device, and a wearable computer.

The user terminal 120 may include a communicator 330 and a controller 340.

The communicator 330 may be configured to communicate with another apparatus as well as the server 110. The communicator 330 may be a same type of communicator as the communicator 310 of the server 110. That is, the communicator 330 may be a hardware module, for example, a network interface card, a network interface chip, and a networking interface port of the user terminal 120, or maybe a software module, for example, a network device driver or a networking program.

The user terminal 120 may include a storage 360 as an apparatus configured to store data or information required to request, receive, and output the recommendation information 230. The storage may include any type of memories or storage devices, and may store a program or an application executed by a controller 340 and information related thereto.

The controller 340 may manage components of the user terminal 120, may execute a program or an application used for the user terminal 120 to request, receive, and output the recommendation information 230, and may process related data and operation. The controller 340 may be at least one processor of the user terminal 120 or at least one core within the processor.

The controller 340 may include a recommendation information requester 342 and a recommendation information acquirer 346. The components 342 and 346 of the controller 340 may be a software or hardware module configured within the controller 340 (or at least one processor of the controller 340). Accordingly, functions and operations of the components 342 and 346 of the controller 340 may be executed by a single processor.

The controller 340 operating as the recommendation information requester 342 may request the server 110 for recommendation information about the first item 130 based on the item information of the first item 130 the user owns or desires to own.

The controller 340 operating as the recommendation information requester 342 or the item information acquirer 322 of the server 110 may acquire item information from an image of the first item 130 captured using a camera (not shown) included in the user terminal 120. For example, the item information of the first item 130 may be extracted from the image of the item 130 included in the captured image of the first item 130, or may be acquired through search using the corresponding image. The request may be transmitted to the server 110 using the communicator 330.

Alternatively, the item information of the first item 130 may be an image itself of the first item 130.

Alternatively, the item information of the item 130 may refer to information pre-stored in the item information database 370 and may be acquired from the item information database 370.

Although not illustrated, the item information database 370 may be constructed in the storage 360 of the user terminal 120. Alternatively, the item information database 370 may be constructed in a server outside the user terminal 120. For example, the item information database 370 may be constructed in the server 110 or the server 100.

The item information database 370 may store item information of an item captured in advance by the user terminal 120. For example, the user may capture items owned by the user such that the recommendation information requester 342 may construct the item information database 370.

Alternatively, the item information database 370 may automatically store item information captured for an item purchased by the user. The recommendation information requester 342 or the item information acquirer 322 of the server 110 may automatically acquire item information of the item purchased by the user and may store the item information in the item information database 370 to construct the item information database 370.

The item information may be identification information used to distinguish the item 130 from another item. The item information may include at least one of information indicating a type of the item 130 (for example, information indicating whether the item 130 is pants, top, or accessories, or a type of accessories, or a type of clothes), information indicating a season of the item 130 (for example, information indicating a season targeted by a released item among spring, summer, autumn, and winter), serial number information associated with the item 130 (for example, a product number), information associated with a color and/or a material of the item 130, information associated with a size of the item 130, and a product name of the item 130. Serial number information associated with the item 130 may include at least a portion of the aforementioned information.

The controller 340 operating as the recommendation information acquirer 346 may acquire the recommendation information 230 from the server 110 in response to a request from the recommendation information requester 342. The recommendation information 230 may be received from the server 110 using the communicator 330.

The recommendation information acquirer 346 may display the acquired recommendation information 230 on a display 350 of the user terminal 120. The display 350 may include a display device configured to output the acquired recommendation information 230. For example, the display 350 may include a touchscreen. That is, the display 350 may be configured to include a function of an inputter not illustrated herein. The user of the user terminal 120 may perform a selection on a setting associated with a request, reception, and output of the recommendation information 230, modification of the output recommendation information 230, acquirement of additional information associated with the recommendation information 230, using the inputter.

The user may be provided with coordination information that fits the first item 130 by verifying the recommendation information 230 displayed on the display 350, and may conveniently verify images and details of second items recommended in relation to the first item 130.

Description related to technical features made above with reference to FIGS. 1 and 2 may apply to FIG. 3 and accordingly, further description is omitted.

FIG. 4 is a flowchart illustrating a method of conducting an image search based on item information about an acquired first item and providing recommendation information to a user terminal according to an example embodiment.

Hereinafter, an operation of the recommendation information providing server 110 of FIG. 3 is further described.

Referring to FIG. 4, in operation 410, the controller 320 of the server 110 operating as the item information acquirer 322 may acquire item information about the first item 130 a user owns or desires to own. As described above with reference to FIG. 3, the item information may be acquired from the user terminal 120 using the communicator 310 or may be acquired from the item information database 370 through the user terminal 120.

In operation 420, the controller 320 of the server 110 operating as the recommendation information generator 324 may acquire a second item associated with the first item 130 based on the acquired item information about the first item 130. The second item may be an item that is recommended to the user based on the recommendation information 230. For example, the second item may be clothes and/or accessories worn around a part of a body different from the first item 130 or may correspond to clothes and/or accessories wearable around to the part of the body with the first item 130.

The recommendation information generator 324 may determine the second item based on at least one of information indicating a type of the first item 130 and season information included in the item information of the first item 130. For example, when the first item 130 is pants for winter (item information indicating pants for winter), the recommendation information generator 324 may recommend a top for winter, a hat for winter, and shoes for winter as second items.

Also, the recommendation information generator 324 may determine the second item based on at least one of information indicating the type of the first item 130 and season information, environmental information of a region set by the user or in which the user is present, statistical information, and preference information preset by the user.

For example, the recommendation information generator 324 may determine, as the second item, an item suitable for a season or a temperature of a region in which the user is present or a temperature of a region set by the user.

Also, the recommendation information generator 324 may use at least one of statistical (or demographical) body information (for example, information about the average weight and/or average height) on bodies of persons, style information (information about statistically preferred fits or styles), fashion information (information about statistically preferred items), and trend information (trend information about preferred items or styles), which are stored in a statistical information database through communication with the statistical information database, to determine the second item. For example, when the first item 130 is verified as striped pants based on the item information of the first item 130, the recommendation information generator 324 may determine a striped shirt as the second item based on fashion information and/or trend information.

Also, the recommendation information generator 324 may determine a second item or may exclude a specific item from the second item based on preference information set (or, alternatively, preset) by the user. For example, when the first item 130 is verified as striped pants based on item information of the first item 130, the recommendation information generator 324 may determine a striped shirt as the second item or may exclude the striped shirt from the second item depending on whether the user is set to like or dislike striped clothes. Preference information may be set through the user terminal 120.

In operation 430, the controller 320 of the server 110 operating as the recommendation information generator 324 may acquire the first image 210 of the first item 130 and the second images 220-1, 220-2, and 220-3 of one or more second items determined to be associated with the first item by searching the image information database 105 based on the item information acquired in operation 410. Operation 430 of acquiring the images 210 and 220-1 to 220-3 may be performed through operations 432 and 434.

In operation 432, the controller 320 of the server 110 operating as the recommendation information generator 324 may select the first image 210 and the second images 220-1, 220-2, and 220-3 such that the first item 130 and the second items may be output visually recognizably through the recommendation information 230. For example, the recommendation information generator 324 may select most suitable respective images from among candidate images of the first item 130 and candidate images of each determined second item, which are retrieved from the image information database 105, as the first image 210 and the second image 220-1, 220-2, and 220-3. A method of determining the first image 210 and the second images 220-1, 220-2, and 220-3 that are most suitable images is further described with reference to FIG. 8.

In operation 434, the controller 320 of the server 110 operating as the recommendation information generator 324 may acquire the selected first image 210 and second images 220-1, 220-2, and 220-3 as images used to generate the recommendation information 230.

In operation 440, the controller 320 of the server 110 operating as the recommendation information generator 324 may generate the recommendation information 230 about the first item 130 that includes a single recommendation image or a single recommendation video by combining (composing) the first image 210 and the second images 220-1, 220-2, and 220-3 acquired in operation 430. The generated recommendation information 230 may constitute a single recommendation image or a single recommendation video as composition of the images 210 and 220-1, 220-2, and 220-3, as described above with reference to FIG. 2.

In operation 450, the controller 320 of the server 110 operating as the recommendation information provider 326 may provide the generated recommendation information 230 to the user terminal 120 of the user. The recommendation information provider 326 may transmit the recommendation information 230 to the user terminal 120 using the communicator 310, and the user may be provided with coordination information that fits the first item 130 by verifying the recommendation information 230 displayed on the display 350.

In operation 460, the controller 320 of the server 110 operating as the recommendation information provider 326 my provide information about purchase of the second item included in the recommendation information 230 in response to a selection from the user on the recommendation information 230. For example, the second item may be an item that is on sale or to be on sale through an online or offline shopping platform. When the second item is an item on sale through an online shopping mall, the recommendation information provider 326 may provide a connection of the user terminal 120 to the online shopping platform to purchase the second item in response to the selection from the user terminal 120 on the recommendation information 230. For example, in response the user selecting, for example, touching, a hat portion corresponding to a portion of the second item of which additional information is desired to acquire in the illustrated recommendation information 230 of FIG. 2, the recommendation information provider 326 may provide a connection (e.g., a URL or an IP address) to an online shopping platform selling the hat.

Here, information provided in operation 460 may include any type of additional information, such as details on the second item, as well as information for purchase provided in response to the selection from the user on the recommendation information 230.

Alternatively, at least one of the first item 130 and the second item may be an item owned by the user. That is, the user may acquire the recommendation information 230 on the first item 130 already owned by the user, through the recommendation information 230. Alternatively, the user may be provided with the recommendation information 230 that includes only the second item owned by the user. That is, the user may be provided with coordination information about only clothes owned by the user as the recommendation information 230.

Alternatively, although not illustrated, in operation 440 of generating the recommendation information, the recommendation information generator 324 may further include composing a photo or another image of the user with the generated recommendation image or recommendation video and generating composed recommendation information. For example, the recommendation information generator 324 may compose the generated recommendation image or recommendation video with a photo of the user selected in response to a selection from the user and may generate the composed recommendation information. The composed recommendation information may correspond to a virtual fitting result of the user on the first item 130 and the second item included in the recommendation information 230. That is, the recommendation information 230 may be used for a virtual fitting service.

For example, the controller 320 may generate a virtual human model of the user based on information, such as a height, a weight, a gender and/or an age of the user, gathered from a sensor of the user terminal 120 and/or input manually by the user. The controller 320 may generate the virtual human model of the user such that the virtual human model is three-dimensional (3D). The controller 320 may fit the first item and the at least one second item on the virtual human model of the user in, for example, the 3D space such that the user is able to rotate the virtual human model in the 3D space to view the item from multiple perspectives.

Description related to technical features made above with reference to FIGS. 1 to 3 may apply to FIG. 4 and accordingly, further description is omitted.

FIG. 5 is a flowchart illustrating an example of a method of generating recommendation information and a method of arranging a first image and a second image in generating the recommendation information according to an example embodiment.

Referring to FIGS. 4 and 5, hereinafter, operation 440 of FIG. 4 is further described with reference to FIG. 5. Operation 440 may include the following operations 510 and 520.

The first item 130 may be an item wearable to a first part of a body of the user, and the second item may be an item wearable to a second part of the body different from the first part.

In operation 510, the controller 320 of the server 110 operating as the recommendation information generator 324 may arrange the first image 210 and the second images 220-1, 220-2, and 220-3 based on relative positions of the first part and the second part relative to the body within the recommendation image or the recommendation video included in the recommendation information 230. The recommendation information generator 324 may rotate and thereby arrange the first image 210 and/or the second images 220-1, 220-2, and 220-3, based on a shape of an item included in a corresponding image such that the recommendation information 230 may represent front shapes of the first item 130 and the second item.

Arranging the first image 210 and the second images 220-1, 220-2, and 220-3 for composite may be performed through operations 512 and 514.

In operation 512, the controller 320 of the server 110 operating as the recommendation information generator 324 may determine a position corresponding to a specific part of a virtual body as a reference position of a recommendation image or a recommendation video to be generated by the recommendation information generator 324. The reference position may be, for example, a center position of an image (image frame) or determined based on the center position. For example, a reference position corresponding to a torso may be determined as a position present in an upper portion from a center of a frame of the recommendation image to be generated, and, as shown in FIG. 2, may be arranged by the recommendation information generator 324 such that a lower end or center of a T-shirt that is the second item may be arranged at the corresponding reference position through the following operation 514.

Meanwhile, aside from the specific part of the virtual body, the recommendation information generator 324 may determine at least a portion of the specific part as the reference position of the recommendation image or recommendation video.

In operation 514, the controller 320 of the server 110 operating as the recommendation information generator 324 may arrange the first image 210 and the second images 220-1, 220-2, and 220-3 based on the determined reference position. For example, the recommendation information generator 324 may arrange the first image 210 at a position corresponding to the first part (a lower body in the example of FIG. 2) of the virtual body based on the determined center position (the position corresponding to the torso of the virtual body). Also, the recommendation information generator 324 may arrange the second images 220-1, 220-2, and 220-3 at positions corresponding to second parts (head, legs, and body in the example of FIG. 2) of the virtual body based on the determined reference position.

In operation 520, the controller 320 of the server 110 operating as the recommendation information generator 324 may generate the recommendation image or the recommendation video included in the recommendation information 230 by composing the first image 210 and the second image 220-1, 220-2, and 220-3 arranged in operation 510.

Through operations 510 and 520, the recommendation information 230 that is not output without being deviated in a specific direction may be generated in the user terminal 120 as illustrated in FIG. 2.

Description related to technical features made above with reference to FIGS. 1 to 4 may apply to FIG. 5 and accordingly, further description is omitted.

FIG. 6 is a flowchart illustrating an example of a method of generating modified recommendation information by modifying recommendation information and providing the modified recommendation information to a user terminal according to an example embodiment.

Referring to FIG. 6, in operation 610, the controller 320 of the server 110 operating as the recommendation information generator 324 may change at least one specific item among the first item and the second items output based on the recommendation information with at least one third item in response to a selection from the user terminal 120 on the recommendation information 230.

In operation 620, the controller 320 of the server 110 operating as the recommendation information generator 324 may generate modified recommendation information that includes a modified recommendation image or a modified recommendation video in which a third image of the third item is combined, instead of using an image of the specific item.

In operation 630, the controller 320 of the server 110 operating as the recommendation information provider 326 may provide the modified recommendation information generated in operation 620 to the user terminal 120.

For example, the user may select, for example, touch, a second item of a portion to be modified in the recommendation information 230 displayed on the user terminal 120. In response to the selection from the user, the recommendation information generator 324 may change the touched second item, for example, a second image of the second item, with the third image of the third item that is a different item and may provide the modified recommendation information to the user terminal 120. Here, the third item may be included in the recommendation information 230 in subsequent order compared to the second item before change and may be an item determined in operation 420 of FIG. 4.

Also, in response to a selection on a portion corresponding to the first item 130 in the recommendation information 230, another item determined to be recommendable for remaining second item(s) may be determined as the third item, and the modified recommendation information in which change to the determined third item is made may be provided to the user terminal 120. Description related to technical features in operation 420 of determining the second item may apply alike to determining the third item.

An example embodiment of providing modified recommendation information is further described with reference to FIG. 9.

Alternatively, dissimilar to the aforementioned example embodiment, in response to a selection from the user on the second item of the portion to be modified in the recommendation information 230 displayed on the user terminal 120, only the second image of the corresponding portion may be changed with another second image of the same second item, for example, a second image corresponding to relatively subsequent order. That is, modified recommendation information in which only an image is changed without changing an item may be provided to the user terminal 120.

Description related to technical features made above with reference to FIGS. 1 to 5 may apply to FIG. 6 and accordingly, further description is omitted.

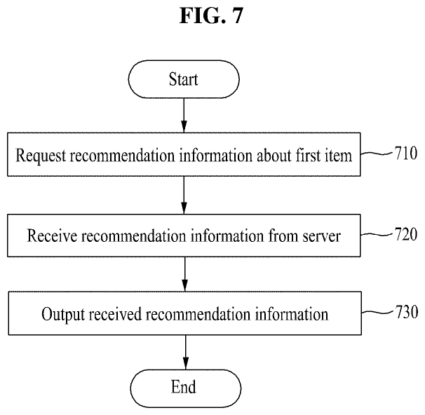

FIG. 7 is a flowchart illustrating a method of requesting, by a user terminal, recommendation information about an item and receiving and outputting the recommendation information according to an example embodiment.

A method of providing, by the user terminal 120, the recommendation information 230 is described from the perspective of the user terminal 120 with reference to FIG. 7.

Referring to FIG. 7, in operation 710, the controller 340 of the user terminal 120 operating as the recommendation information requester 342 may request the server 110 for recommendation information about the first item 130 based on item information about the first item 130 the user owns or desires to own.

In operation 720, in response to the request, the controller 340 of the user terminal 120 operating as the recommendation information acquirer 346 may acquire the recommendation information 230 from the server 110.

In operation 730, the controller 340 of the user terminal 120 operating as the recommendation information acquirer 346 may output the recommendation information 230 received in operation 720 through the display 350.

The user may be provided with coordination recommendation that fits the item 130 the user owns or desires to own based on the recommendation information 230.

Description related to technical features made above with reference to FIGS. 1 to 6 may apply to FIG. 7 and accordingly, further description is omitted.

FIG. 8 illustrates an example of a method of selecting a suitable image for generating recommendation information according to an example embodiment.

Hereinafter, a method of acquiring the suitable first image 210 and second images 220-1, 220-2, and 220-3 in operation 430 of FIG. 4 is further described with reference to FIG. 8. Although only a method of selecting a suitable image 810-3 corresponding to the first image 210 is described herein, the same method may also apply to a method of selecting the second images 220-1, 220-2, and 220-3. The recommendation information generator 324 may select a most suitable image 810-3 as the first image 210 from among candidate images 810-1, 810-2, 810-3, and 810-4. The candidate images 810-1, 810-2, 810-3, and 810-4 may be an image of the first item 130 retrieved from the image information database 105, and the illustrated four images are provided as an example only.

The recommendation information generator 324 may determine the image 810-3 including a front shape of an item related to the image as an image suitable for generating the recommendation information 230. For example, the recommendation information generator 324 may determine an image in which a rotation angle of a shape of an item related to the image is less than or equal to a desired value with respect to at least one of an x axis, a y axis, and a z axis based on a frame of the image, for example, a frame corresponding to an outline of the image, as the image suitable for generating the recommendation information 230.

In the meantime, if the determined suitable image is rotated by using the x axis as a rotational axis by a desired (or, alternatively, a predetermined) angle as shown in the image 810-2, such rotation may be compensated for by performing operation 510. That is, the image may be changed with an image representing a front of the item as shown in the image 810-3.

In the meantime, the recommendation information generator 324 may determine an image that includes a background and an item related to the image from among candidate images as an image suitable for generating the recommendation information 230. For example, when another item or object is included in the image, the corresponding image may be excluded from the image suitable for generating the recommendation information 230.

Also, the recommendation information generator 324 may determine an image of which a resolution is greater than or equal to a desired value among candidate images as the image suitable for generating the recommendation information 230. For example, an image of which a resolution is less than the desired value may be excluded from the image suitable for generating the recommendation information 230.

Also, the recommendation information generator 324 may determine the image that includes the entire shape of an image related item among the candidate images as the image suitable for generating the recommendation information 230. For example, the image 810-1 may be excluded from the image suitable for generating the recommendation information 230.

Description related to technical features made above with reference to FIGS. 1 to 7 may apply to FIG. 8 and accordingly, further description is omitted.

FIG. 9 illustrates an example of a method of displaying modified recommendation information and providing additional information as well as purchase information about a recommended item according to an example embodiment.

In FIG. 9, an item 910 may correspond to the first item 130 and item(s) 920-1, 920-2, and 920-3 may correspond to a second item.

In a first mode, in response to a selection from the user on one of the item 910 and the item(s) 920-1, 920-2, and 920-3, at least one of purchase information, details, and connection to a related online shopping platform about the selected item may be provided.

Also, in a second mode, in response to a selection from the user on one of the item 910 and the item(s) 920-1, 920-2, and 920-3, modified recommendation information in which the selected item is changed with another item may be provided. In the example of FIG. 9, the item 920-2 is selected and modified recommendation information 230′ in which the item 920-2 is changed with another item 920-2′ is provided to the user terminal 120.

The first mode may be an additional information providing mode and the second mode may be an item changing mode. The controller 320 of the server 110 may switch between the first mode and the second mode in response to a selection from the user on a user interface (not shown). Alternatively, the controller 320 of the server 110 may switch between the first mode and the second mode based on using different touch gestures in selecting the item 910 and the item(s) 920-1, 920-2, and 920-3 in 1) and 2).

Description related to technical features made above with reference to FIGS. 1 to 8 may apply to FIG. 9 and accordingly, further description is omitted.

The apparatuses described herein may be implemented using hardware components, software components, and/or a combination thereof. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or at least one combination thereof, for independently or collectively instructing or configuring the processing device to operate as desired. Software and/or data may be embodied permanently or temporarily in any type of machine, component, physical equipment, virtual equipment, computer storage medium or device. The software also may be distributed over network coupled computer systems so that the software is stored and executed in a distributed fashion. The software and data may be stored by one or more computer readable recording mediums.

The methods according to the above-described example embodiments may be recorded in non-transitory computer-readable storage media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable storage media include magnetic media such as hard disks, floppy disks, and magnetic tapes; optical media such as CD-ROM discs, and DVDs; magneto-optical media such as floptical disks; and hardware devices that are specially configured to store and perform program instructions, such as read-only memory (ROM), random access memory (RAM), flash memory, and the like. The media may be various recording devices or storage devices in which a single piece or a plurality of pieces of hardware are combined and may be present on a network without being limited to a medium directly connected to a computer system. Examples of program instructions include both machine code, such as produced by a compiler, and files containing higher level code that may be executed by the computer using an interpreter.

While this disclosure includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of providing recommendation information, the method comprising:
acquiring item information associated with a first item;
acquiring a first image of the first item and second images of at least one second item associated with the first item by searching an image information database based on the item information;
generating the recommendation information associated with the first item based on the first image and the second images; and
outputting the recommendation information to a user terminal.

2. The method of claim 1, wherein the acquiring the item information comprises acquiring the item information from an item information database.

3. The method of claim 2, further comprising:
generating the item information in response to one of a user capturing the first item via an image capturing device of the user terminal or the user purchasing the first item.

4. The method of claim 1, wherein the acquiring of the first image and the second images comprises:
selecting the first image and the second images from among candidate images such that the first item and the at least one second item are output to be visually recognizable to a user through the recommendation information.

5. The method of claim 4, wherein the selecting the first image and the second images comprises:
selecting at least one of the first image and the second images such that the at least one of the first image and the second images includes only the first item or the at least one second item and a background.

6. The method of claim 4, wherein the selecting the first image and the second images comprises:
selecting at least one of the first image and the second images as an image that includes a shape of a front of a related item.

7. The method of claim 4, wherein the selecting the first image and the second images comprises:
selecting at least one image of the first image and the second images as an image in which a rotation angle of a shape of an item related to the image is less than or equal to a desired value with respect to at least one axis based on a frame of the image.

8. The method of claim 4, wherein the selecting the first image and the second images comprises:
selecting at least one image of the first image and the second images to have a resolution of at least a desired value.

9. The method of claim 4, wherein the selecting the first image and the second images comprises:
selecting the first image and the second images to include an entire shape of a related item.

10. The method of claim 1, further comprising:
determining the at least one second item associated with the first item based on information indicating at least one of (i) a type of the first item, (ii) a current season (iii) a geographical region associated with the user terminal, (iv) statistical information, and (v) preference information.

11. The method of claim 1, wherein the first item is wearable to a first part of a body and the second item is wearable to a second part of the body excluding the first part, and the generating of the recommendation information comprises:
arranging the first image and the second images based on relative positions of the first part and the second part relative to the body to generate an arranged first image and arranged second images, respectively; and
generating the recommendation information by composing the arranged first image and the arranged second images in one of a single recommendation image or a single recommendation video.

12. The method of claim 11, wherein the arranging of the first image and the second images comprises:
determining a position corresponding to a specific part of a virtual body as a reference position; and
arranging the first image and the second images in one of a single recommendation image or a single recommendation video based on the reference position.

13. The method of claim 4, further comprising:
replacing at least one of the first item and the second item with at least one third item in response to a selection from the user after displaying the recommendation information;
generating modified recommendation information that includes a third image of the third item; and
outputting the modified recommendation information to the user terminal.

14. The method of claim 1, wherein the second item is purchasable by a user of the user terminal.

15. The method of claim 14, further comprising:
connecting the user terminal to a website to purchase the second item based on a selection of the second item.

16. The method of claim 1, wherein a user of the user terminal possesses at least one of the first item and the at least one second item.

17. The method of claim 1, wherein the generating of the recommendation information comprises:
generating a virtual model of a user of the user terminal based on the recommendation information such that the virtual model is virtually fitted with the first item and the at least one second item.

18. A non-transitory computer-readable recording medium storing a program to perform the method according to claim 1.

19. A recommendation information providing server comprising:
a memory; and
processing circuitry configured to,
acquire item information associated with a first item,
acquire a first image of the first item and second images of at least one second item associated with the first item by searching an image information database based on the item information,
generate recommendation information associated with the first item based on the first image and the second images,
output the recommendation information to a user terminal.

20. A method of providing recommendation information, the method comprising:
transmitting, to a server, a request for recommendation information associated with a first item based on item information associated with the first item;
receiving the recommendation information from the server in response to the request such that the recommendation information combines a first image of the first item and second images of at least one second item associated with the first item, the first image and the second images being acquired via an image information database based on the item information; and
displaying, on a display device, the recommendation information.
